(19) United States
(12) Patent Application Publication
(10) Pub. No.: US 2025/0117458 A1
(43) Pub. Date: Apr. 10, 2025

(54) SYSTEMS AND METHODS FOR SECURING CONTENT

(71) Applicant: Capital One Services, LLC, McLean, VA (US)

(72) Inventors: Shahalam BAIG, Rochester, NY (US); Matthew HUNSBERGER, Hoboken, NJ (US); Shasanka BHANDARI, McLean, VA (US); Hyunwoo KANG, New York, NY (US)

(73) Assignee: Capital One Services, LLC, McLean, VA (US)

(21) Appl. No.: 18/905,183

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10; G06F 21/60; G06F 21/62; H04L 67/02

(52) U.S. Cl. CPC G06F 21/1066; G06F 21/602; G06F 21/6245; H04L 67/02

(57) ABSTRACT

A method may include receiving, using a first application programming interface (API) endpoint of an API system, an API request from a computing device. The API request may represent a request for a video that is associated with a digital rights management technology and that includes an image frame representing a content element. The method may include fetching, using the first API endpoint, the content element. The method may include forming, using the API system, a JavaScript Object Notation (JSON) object including the content element and formatting information associated with the content element. The method may further include transmitting, using a second API endpoint of the API system, the JSON object to an application server configured to generate the video based on the JSON object.

### CROSS-REFERENCE TO RELATED APPLICATION(S)

This application claims the benefit of pending U.S. Provisional Patent Application No. 63/587,891, filed on Oct. 4, 2023, and claims the benefit of pending U.S. Provisional Patent Application No. 63/665,485, filed on Jun. 28, 2024, and claims the benefit of pending U.S. Provisional Patent Application No. 63/683,063, filed Aug. 14, 2024, each of which is incorporated herein by reference in its entirety.

### TECHNICAL FIELD

Various embodiments of this disclosure relate generally to techniques for securing content, and more particularly to systems and methods for securing content of a portal (e.g., a webpage, a website, an application, or the like).

### BACKGROUND

Organizations such as banks and healthcare providers seek to protect sensitive information (e.g., confidential information, personally identifiable information, financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, the target may be a user who uses a browser presented on a display screen (also referred to herein as a “screen”) of a computing device to view an account number on a bank's website. A social engineer using another computing device may persuade the user to reveal the account number to the social engineer. More specifically, the social engineer may convince the user to share the user's screen displaying the account number with the social engineer, using a screensharing or remote desktop application. In addition or in the alternative, the social engineer may convince the user to take a screenshot of the user's screen displaying the account number, using a screenshotting application, and to then transmit the screenshot to the social engineer.

To guard against such social engineering, the bank may employ a technology that limits the use of digital content provided on the bank's website. However, such a technology may not protect the digital content when the digital content is included in the user's browser (e.g., as an HTML page), or is being loaded to the user's display screen.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for securing content of a portal (e.g., a webpage, a website, an application, or the like) are disclosed. Each of the examples disclosed herein may include one or more features described in connection with any of the other disclosed examples.

In one aspect, an exemplary embodiment of a method may include receiving, using a first application programming interface (API) endpoint of an API system, an API request from a computing device. The API request may represent a request for a video that is associated with a digital rights management technology and that includes an image frame representing a content element. The method may include fetching, using the first API endpoint, the content element. The method may include forming, using the API system, a JavaScript Object Notation (JSON) object including the content element and formatting information associated with the content element. The method may further include transmitting, using a second API endpoint of the API system, the JSON object to an application server configured to generate the video based on the JSON object.

In a further aspect, an exemplary embodiment of a system may include at least one processor and at least one memory having programming instructions stored thereon, which, when executed by the at least one processor, cause the system to perform operations. The operations may include receiving, using a first application programming interface (API) endpoint, an API request for a video that is associated with a digital rights management technology and that includes an image frame representing a content element, from a computing device. The operations may include fetching, using the first API endpoint, the content element. The operations may include forming, using an API system, a JavaScript Object Notation (JSON) object including the content element and formatting information associated with the content element. The operations may further include transmitting, using a second API endpoint, the JSON object to an application server configured to generate the video based on the JSON object.

In another aspect, an exemplary embodiment of a method may include receiving, using a first application programming interface (API) endpoint of an API system, an API request for a video that is associated with a digital rights management technology and that includes an image frame representing sensitive information, from a computing device. The method may include fetching, using the first API endpoint, the sensitive information. The method may include forming, using the API system, a JavaScript Object Notation (JSON) object including the sensitive information and formatting information associated with the sensitive information. The method may include transmitting, using a second API endpoint of the API system, the JSON object to an application server configured to generate the video based on the JSON object.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2 depicts a flowchart of an example method, according to one or more embodiments.

FIG. 3 depicts a flowchart of an example method, according to one or more embodiments.

FIG. 4 depicts a flowchart of an example method, according to one or more embodiments.

FIG. 5 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context,

As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11, an application accessed using a Print Screen key of a keyboard or keypad, or the like).

As used herein, the term “content element” may refer to data such as text data (e.g., letters, numbers, symbols, metadata, or alt text), image data (e.g., an image, a graphic, a sequence of image frames, or a video), or audio data (e.g., a sequence of audio frames). In some aspects, a content element may include static information or static content such as data that is fixed or stationary, non-video data, text data (e.g., letters, numbers, symbols, metadata, or alt text) or image data (e.g., an image or graphic). In some embodiments, a content element may be dynamic (e.g., configured to change over time), such as an animated graphic or a video advertisement. Further, in some embodiments, a content element may be interactive (e.g., configured to respond to an input from a user of a computing device), such as a button, a toggle switch, a field configured to display text, a link (e.g., a hyperlink), an icon that may be selected to launch an application, text that may be highlighted or selected (e.g., using a cursor), or one or more images that may be highlighted or selected (e.g., using a cursor). In some aspects, a content element may include one or more content elements.

As used herein, the term “sensitive information” may refer to data that is intended for, or restricted to the use of, one or more users or entities. Sensitive information may represent data that is personal, private, confidential, privileged, secret, classified, or in need of protection. Examples of sensitive information may include financial data such as account numbers, credit card account numbers, checking account numbers, virtual card numbers, savings account numbers, account balances, credit card account balances, checking account balances, savings account balances, financial statements, bills, or invoices; personally identifiable information such as a name, address, phone number, social security number, or driver's license number; medical information such as a patient's medical history, a doctor's summary or diagnosis, or medical test results; academic information such as a student's grades or transcript; business information such as trade secrets, proprietary information, alpha product releases, or business strategy information; governmental information such as classified or secret information related to national security or defense); or data that is copyrighted, etc.

As used herein, the term “HTML page” may refer to a file that includes HTML, and that defines the structure and content of a webpage or website. An HTML element may represent a component of an HTML page, and may include, for example, a start tag, an end tag, a content element, or a reference to a content element (e.g., a link, hyperlink, address, or path to a content element). In some embodiments, an HTML element may include one or more HTML elements (e.g., nested HTML elements).

As used herein, the term “Cascading Style Sheet” (also referred to herein as “CSS”) may refer to a language used to describe the presentation (e.g., formatting, layout, sizing, positioning, coloring, etc.) of content of a webpage or website. A “CSS rule” may refer to a rule (or property) that is written in CSS and that, when applied, describes the presentation of content of a webpage or website. In some aspects, one or more CSS rules may be included in a CSS file (e.g., a file with the extension, “.css”), which may be referenced by an HTML page. One or more CSS rules may also be directly included in an HTML page.

As used herein, the term “application programming interface” (API) may refer to a set of protocols, rules, or subroutines that enables computer programs (e.g., software or electronic applications) to communicate with each other or exchange data, features, or functionality. An API system may refer to a computing device or server that includes one or more APIs or API endpoints, and that is configured to receive and respond to one or more API requests (or API calls), from a computing device (e.g., a user device). The term “API endpoint” may refer to a digital location (e.g., a uniform resource locator (“URL”)) where an API or API system receives one or more API requests regarding a resource provided on (or associated with) the API or API system. The term “API request” or “API call” may refer to a message sent to an API system (or API) that asks the API system (or an API, or an API associated with an API system) to perform a service or provide information. In some embodiments, an API request may include or be associated with (i) one or more content elements of a webpage and (ii) a request that an API system perform one or more actions. The one or more actions may include, for example, one or more of retrieving one or more content elements that represent sensitive information; retrieving or receiving formatting information associated with the one or more retrieved content elements; packaging the one or more retrieved content elements, along with formatting information associated with the one or more retrieved content elements, as a JSON object; transmitting the JSON object to an application server; forwarding one or more content elements that include sensitive information or non-sensitive information to the application server; directing the application server to retrieve one or more content elements representing sensitive information; directing the application server to generate or store a DRM-protected video that includes an image frame depicting one or more content elements (e.g., representing sensitive information or non-sensitive information), or transmitting a link (e.g., a hyperlink) to a computing device (e.g., user device), where the link is configured to direct the computing device to a DRM-protected video that includes an image frame depicting one or more content elements.

As used herein, the term “JavaScript Object Notation” (“JSON”) may refer to a format used to store or transmit data (or one or more content elements). The term “JavaScript Object Notation object” or “JSON object” may refer to data, or one or more content elements, formatted in accordance with JSON. In some embodiments, a JSON object may include one or more name/value pairs or one or more name/array pairs. In some aspects, a JSON object may be enclosed within (or include) curly braces (e.g., {, }). An array included in a JSON object may be enclosed within (or include) square brackets (e.g., [,]).

As used herein, the term “formatting information” may refer to data (or one or more content elements) that describe how other data (or one or more other content elements) should be, or is currently being, presented on a display screen (e.g., within an image frame of a DRM-protected video being played on the display screen). For example, formatting information may represent one or more of a font, a color, a background color, a font size, a position, a resolution, or other stylistic or aesthetic attribute (or property) of one or more content elements to be displayed, or being displayed, on a display screen. In some embodiments, formatting information may include one or more Cascading Style Sheets or CSS rules. Further, in some embodiments, formatting data may represent metadata.

As used herein, a “machine learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as a neural network(s), convolutional neural network(s), regional convolutional neural network(s), mask regional convolutional neural network(s), deformable detection transformer(s), linear regression, logistical regression, random forest, gradient boosted machine (GBM), deep learning, or a deep neural network. Supervised or unsupervised training may be employed. For example, supervised learning may include providing training data and labels corresponding to the training data, e.g., as ground truth. Unsupervised approaches may include clustering, classification or the like. Any suitable type of training may be used, e.g., stochastic, gradient boosted, random seeded, recursive, epoch or batch-based, etc.

In the following description, embodiments will be described with reference to the accompanying drawings. As will be discussed in more detail below, various embodiments, methods, and systems for securing content of a portal (e.g., a webpage, a website, an application, or the like) are described.

In a first exemplary use case, a customer of a bank may use a computing device, such as a laptop, to obtain financial information. More specifically, the customer may use a browser presented on a display screen of the laptop to enter a web address (or URL) of a webpage that is associated with the bank, where the customer anticipates viewing the customer's checking account number on the webpage. In some aspects, the checking account number may represent sensitive information. Sensitive information may refer to data that is intended for, or restricted to the use of, one or more users or entities (e.g., the customer and the bank).

Once the web address is entered, the browser may retrieve an HTML page that represents the webpage. In some aspects, the browser may be configured to receive sensitive information included in the webpage (e.g., the customer's checking account number) only when the sensitive information is represented in an image frame of a DRM-protected video. In some embodiments, the retrieved HTML page may represent the entire webpage except for any sensitive information, such as the customer's checking account number. The browser may subsequently determine that the customer's checking account number is not included in the retrieved HTML page, and then transmit, to an API system, an API request for a DRM-protected video that includes a single image frame, where the image frame represents (or depicts) the customer's checking account number. In some embodiments, the requested DRM-protected video may be configured to play the image frame in a loop on the display screen of the customer's laptop when the display screen is not being screenshared or screenshotted. Further, the requested DRM-protected video may be configured to not play (or be blocked from playing) on the display screen when the display screen is being screenshared or screenshotted.

Subsequent to transmitting the API request, the browser may receive the requested DRM-protected video from an application server. The browser may further form an HTML element that includes the DRM-protected video, where the HTML element may be included (or inserted) in the retrieved HTML page of the webpage. The browser may also load (e.g., generate a Document Object Model of), render, and output, to the display screen of the customer's laptop, the DRM-protected video and the webpage, where the DRM-protected video may be overlaid on, for example, a background color of the webpage on the display screen. In some aspects, a player (e.g., a JavaScript player) may be used to render the DRM-protected video, and so long as the display screen is not being screenshared or screenshotted, play the DRM-protected video in a loop on the display screen. During the playing, the checking account balance may appear to the customer as a still image presented on the display screen.

In some aspects, because the browser is configured to receive the customer's checking account number only when the customer's checking account number is represented in an image frame of a DRM-protected video, the checking account number is protected from unauthorized access (e.g., by a social engineer or malicious web application) as soon as the browser module received the DRM-protected video. Further, the checking account number remains protected during all stages of loading, including when the DRM-protected video and the webpage are represented in a Document Object Model. As a result, a social engineer or malicious web application cannot directly access or view the checking account number represented in the Document Object Model (e.g., by directly manipulating the Document Object Model). Further, when the DRM-protected video is presented on the display screen, the checking account number is protected because the DRM-protected video is configured to play the image frame representing the checking account number only when the display screen is not being screenshared with, or screenshotted, for a social engineer or potential social engineer, for example.

Accordingly, embodiments described herein provide an end-to-end process for securing sensitive information of a webpage from unauthorized access. In some embodiments, the techniques described herein may be implemented using only JavaScript, and as a result, these techniques are relatively flexible and may be customized. For example, the techniques disclosed herein may be integrated with, and accessed using, a variety of web development tools including front end libraries (e.g., React) and front-end frameworks (e.g., Angular), in order to secure content.

While the exemplary use case above involves a webpage and sensitive information, it should be understood that techniques according to this disclosure may be adapted to any suitable type of program (e.g., a website, portal, application, browser extension, plugin, etc.) and data (e.g., static information, sensitive information, non-sensitive information, text data, image data, audio data, etc.), respectively. Further, in some embodiments, the webpage may include multiple pieces of sensitive (or non-sensitive) information that may be represented in one or more image frames of one or more DRM-protected videos. In some embodiments, asynchronous JavaScript (or asynchronous processing) may be used to protect each of the multiple pieces of sensitive (or non-sensitive) information. It should also be understood that the example above is illustrative only. The techniques and technologies of this disclosure may be adapted to any suitable activity.

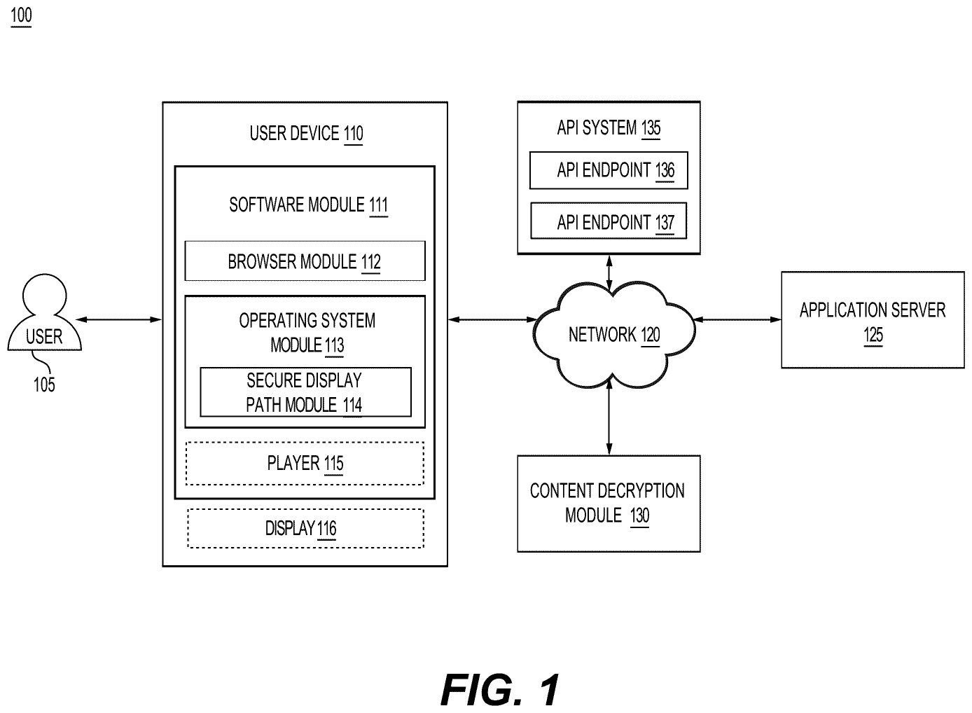

FIG. 1 depicts an example environment 100 that may be utilized with techniques presented herein. In some aspects, the environment 100 may be an embodiment of (i) the environment 100 described in U.S. Provisional Application 63/587,891, filed on Oct. 4, 2023, (ii) the environment 100 described in U.S. Provisional Application 63/665,485, filed on Jun. 28, 2024, or (iii) the environment 100 described in U.S. Provisional Patent Application No. 63/683,063, filed Aug. 14, 2024 where each of these U.S. provisional applications is incorporated by reference herein in its entirety. As shown in FIG. 1, the environment 100 may include a user device 110, a network 120 (e.g., an electronic network), an application server 125, an application programming interface system 135 (also referred to herein as the “API system 135”), and a content decryption module 130 (also referred to herein as the “CDM 130”). In some aspects, the user device 110, the application server 125, the API system 135, and the CDM 130 may communicate with one another in any arrangement across the network 120. The user device 110 may be associated with a user 105. In some embodiments, the user 105 may be a customer or employee of, or contractor for, a company, business, or organization (e.g., a bank, a hospital, a university, etc.), or the like. Further, in some embodiments, the company, business, or organization may be associated with (e.g., own, rent, or control) the user device 110. In some other embodiments, the user 105 may own, rent, or control the user device 110. Further, in some embodiments, the user 105 may be an authorized user of the user device 110 and a portal accessed using the user device 110.

The user device 110 may be configured to enable the user 105 to access or interact with the network 120, the application server 125, the API system 135, and the CDM 130, in the environment 100. For example, the user device 110 may be a computer system such as a desktop computer, a laptop, a workstation, a mobile device, a tablet, etc. In some embodiments, the user device 110 may include one or more software modules, which may represent electronic application(s) such as a program, a platform, a plugin, or a browser extension, installed on a memory of the user device 110. For example, as shown in FIG. 1, the user device 110 may include a software module 111 that may represent (or include), for example, a browser module 112, an operating system module 113, and optionally a player 115. The player 115 may represent a video player configured to play back one or more videos, or present image frames (or video frames) of one or more videos on a display screen. In some embodiments, the player 115 may be included in the browser module 112 or the operating system module 113 (not shown in FIG. 1). In some other embodiments, the player 115 may represent hardware included in the user device 110 (not shown in FIG. 1). In some embodiments, the player 115 may represent an interactive video player, which is a video player configured to play back a video, where a user (e.g., the user 105) may interact with the video (e.g., by selecting a button presented in the video) during the playback on a display screen. The user device 110 may also optionally include a display 116, which may represent a display screen configured to display or present data (optionally using the player 115), where the data may be received from the browser module 112 or the operating system module 113.

The browser module 112 may include one or more browsers (e.g., web browsers or applications for accessing and viewing content on the internet, the World Wide Web, a cloud platform, etc.). In some embodiments, the browser module 112 may be configured to communicate with the operating system module 113, the display 116, the network 120, and the application server 125, the API system 135, and the CDM 130, via the network 120. For example, in response to the user 105 inputting a web address (or uniform resource locator) to the browser module 112 (e.g., using the display 116 or a keyboard or other input/output device associated with the user device 110), the browser module 112 may be configured to transmit a request for a webpage (or website, portal, application, etc.) associated with the web address, to the application server 125 via the network 120. The browser module 112 may also be configured to receive the webpage (e.g., an HTML page corresponding to, or representing, the webpage) from the application server 125 via the network 120. As used herein, the term “HTML page” may refer to a file that includes HTML, and that defines the structure and content of a webpage (or website, portal, application, etc.). In some aspects, the browser module 112 may be configured to load, render, or output the webpage (or a portion of the webpage) to the display 116 directly, or indirectly via the operating system module 113. When the browser module 112 loads the webpage (or a portion of the webpage), the browser module 112 may, for example, parse an HTML page representing the webpage, and convert the parsed HTML page into a Document Object Model (“DOM”). As used herein, a DOM may refer to a tree structure that represents the structure of an HTML page. In some aspects, the tree structure may include one or more nodes, where each of the one or more nodes represents a part of the HTML page (e.g., an HTML element, an attribute, a piece of text, an image, or the like).

In some aspects, the webpage (or HTML page corresponding to the webpage) received by the browser module 112 from the application server 125 may include one or more content elements (or represent a single content element). In some aspects, a content element may represent data such as text data (e.g., letters, numbers, symbols, metadata, or alt text), image data (e.g., an image, a graphic, a sequence of image frames, or a video), or audio data (e.g., a sequence of audio frames). Further, in some aspects, a content element may include static information. As used herein, the term “static information” may refer to data that is fixed or stationary, or non-video data. For example, static information may represent text data (e.g., letters, numbers, symbols, metadata, or alt text) or image data (e.g., an image or graphic). In some embodiments, a content element may be dynamic (e.g., configured to change over time), such as an animated graphic or a video advertisement. Further, in some embodiments, a content element may be interactive (e.g., configured to respond to an input from a user of a computing device), such as a button, a toggle switch, a field configured to display text, a link (e.g., a hyperlink), an icon that may be selected to launch an application, text that may be highlighted or selected (e.g., using a cursor), or one or more images that may be highlighted or selected (e.g., using a cursor). In some aspects, a content element may include one or more content elements. Further, a content element may represent data included in, or referred by, an HTML element of the HTML page representing the webpage. An HTML element may represent a component of an HTML page, and may include, for example, a start tag, an end tag, and as noted above, a content element or a reference to a content element (e.g., a link, hyperlink, address, or path to a content element). Further, in some embodiments, an HTML element may include one or more HTML elements (e.g., nested HTML elements).

In some embodiments, one or more content elements of the webpage may include sensitive information or non-sensitive information. As explained above, sensitive information may refer to data that is intended for, or restricted to the use of, one or more users or entities (e.g., the user 105 and an organization associated with the application server 125 or the API system 135). Moreover, sensitive information may represent data that is personal, private, confidential, privileged, secret, classified, or in need of protection. Sensitive information may further represent, for example, financial data such as account numbers, credit card account numbers, checking account numbers, savings account numbers, virtual card numbers, account balances, credit card account balances, checking account balances, savings account balances, financial statements, ledgers, bills, or invoices; personally identifiable information such as a name, address, phone number, social security number, or driver's license number; medical information such as a patient's medical history, a doctor's summary or diagnosis, or medical test results; academic information such as a student's grades or transcript; business information such as trade secrets, proprietary information, or business strategy information; governmental information such as classified or secret information related to national security or defense; or data that is copyrighted, etc.

In some embodiments, the browser module 112 may be configured to determine whether one or more content elements of a webpage (e.g., an HTML page corresponding to the webpage) received by the browser module 112 from the application server 125, include sensitive information, and to transmit this determination to the application server 125 via the network 120. For example, the browser module 112 may use (and optionally include) a trained machine learning model configured to predict whether any content elements in the received webpage include sensitive information. Where one or more contents elements of the received webpage are predicted to include sensitive information, the browser module 112 may transmit the one or more content elements to the application server 125. Further, the browser module 112 may receive one or more DRM-protected videos representing the transmitted one or more content elements from the application server 125 (e.g., via the CDM 130).

In some embodiments, the browser module 112 may be configured to receive one or more (or all) content element(s) of a webpage that represent sensitive information, from the application server 125 (e.g., via the CDM 130), only when such content element(s) are associated with (e.g., protected by) a DRM technology. Further, the browser module 112 may be configured to receive one or more (or all) content element(s) of a webpage that represent only non-sensitive information from the application server 125 (e.g., via the CDM 130), regardless of whether such content element(s) are associated with (e.g., protected by) a DRM technology. For example, where a webpage to be transmitted to the browser module 112 (e.g., from the application server 125) includes two content elements that are not protected by a DRM technology, and where one of the content elements includes sensitive information and the other content element includes non-sensitive information, the browser module 112 may receive an HTML page corresponding to the webpage that includes only the content element including the non-sensitive information. Further, the browser module 112 may determine that the content element representing the sensitive information is not included in (or is missing from) the received HTML page. Alternatively, the browser module 112 may receive a notification from the application server 125 that the content element representing the sensitive information is not included in the HTML page received by the browser module 112.

In some embodiments, in response to the browser module 112 determining (or receiving a determination) that a webpage (or HTML page corresponding to the webpage) received by the browser module 112 does not include (or is missing) one or more content elements representing sensitive information, the browser module 112 may transmit an API request (or API call) to the API system 135, via the network 120, to request the one or more content elements representing sensitive information. More specifically, the browser module 112 may transmit an API request (optionally using JavaScript) to the API system 135, via the network 120, to request one or more DRM-protected videos that include image frame(s) representing or depicting the one or more content elements representing the sensitive information. For example, the browser module 112 may transmit an API request to the API system 135, via the network 120, to request a DRM-protected video that includes a single image frame, where the single image frame represents sensitive data. The requested DRM-protected video may be configured to play the single image frame in a loop on the display 116 when the display 116 is not being screenshared or screenshotted. The requested DRM-protected video may be configured to not play on the display 116 when the display 116 is being screenshared or screenshotted. In some embodiments, the browser module 112 may be configured to transmit an API request to the API system 135, where the API request may be an embodiment of the API request described in U.S. Non-Provisional Application [Client Ref. IDF14706, attorney docket number 00212-0385-00000], filed Oct. 3, 2024, which is incorporated by reference herein in its entirety.

Further, in some embodiments, the API request may include formatting information associated with one or more content elements that represent sensitive information and are not included in an HTML page representing a webpage. In some aspects, the formatting information may represent, for example, data that describe how the one or more content elements representing the sensitive information should be presented in one or more image frames of one or more DRM-protected videos (or how the one or more content elements representing the sensitive information should be presented on the display 116). The formatting information may represent one or more of a font, a color, a background color, a font size, a position, a resolution, or other stylistic or aesthetic attribute (or property) of the one or more content elements representing the sensitive information. In some embodiments, the formatting information may include one or more Cascading Style Sheets or CSS rules. Further, in some embodiments, formatting data may represent metadata.

In some embodiments, the browser module 112 may be configured to receive one or more DRM-protected videos from the application server 125 (optionally via the CDM 130), responsive to transmitting an API request to the API system 135. For example, subsequent to transmitting an API request to the API system 135, the browser module 112 may receive a DRM-protected video that includes an image frame depicting one or more content elements representing sensitive information (and optionally non-sensitive information) of a webpage, from the application server 125 via the CDM 130. The browser module 112 may further be configured to form one or more HTML elements that include one or more DRM-protected videos (or other content elements) received from the application server 125, where the one or more formed HTML elements may be included in an HTML page corresponding to a webpage. Further, subsequent to forming the one or more HTML elements of the HTML page, the browser module 112 may be configured to load, render, and output the HTML page to the display 116. In some embodiments, the browser module 112 may load, render, and output one or more (or all) content elements of the HTML page that include only non-sensitive information directly to the display 116, or optionally indirectly to the display 116, via the operating system module 113. Further, in some embodiments, the browser module 112 may load, render, and output one or more (or all) content elements of the HTML page that include sensitive information (e.g., a DRM-protected video that includes an image frame representing sensitive information) to the display 116 via the operating system module 113. Accordingly, the browser module 112 may be configured to communicate with the operating system module 113 by, for example, transmitting one or more DRM-protected videos or other content elements to the operating system module (e.g., via a secure display path module 114).

In some embodiments, the operating system module 113 may include one or more operating systems. In some aspects, an operating system may represent software configured to (i) manage hardware and software resources of the user device 110 or (ii) provide services for applications associated with the user device 110. In some embodiments, the operating system module 113 may include the secure display path module 114 (also referred to herein as the “secure display path 114”). In some embodiments, the operating system module 113 (or the secure display path 114) may be configured to receive one or more HTML pages or webpages (e.g., optionally excluding or missing content elements that represent sensitive information) from the application server 125 (e.g., via the CDM 130) in a manner similar to that described above with reference to the browser module 112. Further, the operating system module 113 (or the secure display path 114) may be configured to transmit one or more API requests (e.g., using JavaScript, and for a DRM-protected video including an image frame that depicts sensitive information) to the API system 135, in a manner similar to that described above with respect to the browser module 112. The operating system module 113 (or the secure display path 114) may also be configured to receive one or more DRM-protected videos from the application server 125 (e.g., using JavaScript, and via the CDM 130), responsive to transmitting one or more API requests for such DRM-protected video(s), in a manner similar to that described above with reference to the browser module 112. Further, the operating system module 113 (or the secure display path 114) may be configured to receive one or more content elements (e.g., other than DRM-protected videos) from the application server 125 (e.g., via the CDM 130).

In some aspects, the secure display path 114 may represent (or include) one or more DRM technologies (or DRM functions) used to protect or secure content element(s) that the secure display path 114 receives (or retrieves) from the browser module 112, the application server 125, the API system 135, or the CDM 130. The secure display path 114 may be native (or specific) to a respective operating system of the operating system module 113. In some embodiments, the secure display path 114 may represent Microsoft's Protected Media Path, for example.

In some aspects, the secure display path module 114 may be configured to load, render, or output to the display 116, one or more content elements of a webpage for presentation, optionally while the browser module 112 concurrently loads, renders, or outputs to the display 116, the remainder (or a portion of) of the webpage for presentation. For example, where a content element of a webpage represents a DRM-protected video and includes an image frame depicting sensitive information (e.g., a checking account balance), the secure display path module 114 may load, render, or output the DRM-protected video to the display 116 while the browser module 112 concurrently loads, renders, or outputs to the display 116, the remainder (or a portion) of the webpage (e.g., a portion of the webpage that excludes the DRM-protected video and the sensitive information). In some embodiments, the DRM-protected video may be presented over background color(s) of the remainder (or a portion) of the webpage, on the display 116.

In some aspects, the secure display path 114 may be configured to protect (or secure) one or more content elements by blocking or preventing the one or more content elements from being loaded, rendered, or output to or played on the display 116, when the display 116 is being screenshared (e.g., using a screensharing application or remote desktop application) or screenshotted (e.g., using a screenshotting application). For example, in some embodiments, the user 105 may view a DRM-protected video overlaid on a webpage on the display 116, and so long as the display 116 is not screenshared or screenshotted, the DRM-protected video may be played on the display 116. While the DRM-protected video is played, the user 105 may be able to see a content element (e.g., a credit card balance) that is represented in an image frame of the DRM-protected video. However, if the user 105 attempts to screenshare or take a screenshot of the display 116 with a social engineer (or potential social engineer), the secure display path 114 may cause the DRM-protected video to stop playing (or be blocked from playing) so that the social engineer (or potential social engineer) and the user 105 cannot see the content element.

The API system 135 may include a server or other computing device, and may be configured to interact with other systems, such as the user device 110, the application server 125, or the CDM 130, in the environment 100. In some embodiments, the API system 135 may be associated with (e.g., owned, rented, or controlled by) a company, a business, or an organization, such as a bank, a hospital, a university, or a merchant, etc. Further, in some aspects, the API system 135 may include one or more API endpoints, where an API endpoint may refer to a digital location (e.g., a uniform resource locator) where the API system 135 receives one or more API requests (or API calls) regarding a resource provided on (or associated with) the API system 135. In some aspects, an API request (or API call) may refer to a message sent to the API system 135 that asks the API system 135 to perform a service or provide information. In some embodiments, and as shown in FIG. 1, the API system 135 may include an API endpoint 136 (also referred to herein as the “first API endpoint 136”) and an API endpoint 137 (also referred to herein as the “second API endpoint 137”).

In some embodiments, the first API endpoint 136 may be configured to receive (e.g., using JavaScript) one or more API requests from the user device 110 (e.g., the browser module 112 or the operating system module 113). For example, the first API endpoint 136 may be configured to receive an API request from the user device 110, where the API request includes a request for a DRM-protected video that (i) includes a single image frame, where the single image frame represents one or more content elements that include sensitive information and that are formatted in accordance with formatting information, (ii) is configured to play the single image frame in a loop on the display 116 of the user device 110 when the display 116 is not being screenshared or screenshotted, and (iii) is configured to not play on the display 116 when the display 116 is being screenshared or screenshotted. In some embodiments, the API request may further include the formatting information. In some other embodiments, the API request may not include the formatting information.

In response to receiving an API request, the first API endpoint 136 may fetch, retrieve, or receive (e.g., using JavaScript) one or more content elements representing sensitive information that is referenced or requested in the received API request (e.g., optionally using the network 120). Where the received API request does not include formatting information associated with the one or more content elements representing the sensitive information, the first API endpoint 136 may fetch, retrieve, or receive the formatting information (e.g., from the API system 135 or using the network 120). Further, in some embodiments, the first API endpoint 136 may be configured to form a JSON object that includes the sensitive information (e.g., as a string) and formatting information associated with the sensitive information. In some other embodiments, the first API endpoint 136 may be configured to append the sensitive information (e.g., as a string) and formatting information associated with the sensitive information to a JSON object. In some aspects, JSON may refer to a format used to store or transmit data (e.g., one or more content elements), and a JSON object may refer to data (e.g., one or more content elements) formatted in accordance with JSON. In some embodiments, a JSON object may include one or more name/value pairs or one or more name/arrays. Further, a JSON object may be enclosed within (or include) curly braces (e.g., {, }). An array included in a JSON object may be enclosed within (or include) square brackets (e.g., [,]). An example JSON object that includes a bank account number (e.g., sensitive information) and formatting information (e.g., font size, font color, background color, image size, and font) associated with the bank account number is provided below.

```
{
  “text”: “Bank Account No. 12345”,
  “font_size”: 30,
  “font_color”: “black”,
  “background_color”: “white”,
  “image_size”: [320, 240],
  “font”: “Arial”
}
```

In some embodiments, the API system 135, or an endpoint of the API system 135 other than the first API endpoint 136 (e.g., the second API endpoint 137), may be configured to form the JSON object. Further, the API system 135, the first API endpoint 136, or another endpoint of the API system 135 (other than the second API endpoint 137) may be configured to transmit or send the formed JSON object to the second API endpoint 137 (e.g., using JavaScript). The second API endpoint 137 may be configured to transmit or send (e.g., using JavaScript) the received JSON object to the application server 125 via the network 120.

The application server 125 may be a computing system such as a server, a workstation, a desktop computer, a laptop, a mobile device, a tablet, etc. In some examples, the application server 125 may be associated with (or include) a cloud computing platform with scalable resources for computation or data storage. The application server 125 may run one or more applications locally or using the cloud computing platform, to perform various computer-implemented methods described in this disclosure. In some embodiments, the application server 125 may be associated with (e.g., owned, rented, or controlled by) a company, a business, or an organization, such as a bank, a hospital, a university, or a merchant, etc.

In some aspects, the application server 125 may be configured to communicate with the user device 110, the API system 135, and the CDM 130, via the network 120. For example, the application server 125 may be configured to transmit an HTML page (or file) corresponding to a webpage to the browser module 112 or the operating system module 113, via the network 120. In some embodiments, the application server 125 may be configured to receive a notification (or determination) from the browser module 112 that one or more content elements of the HTML page include sensitive information. Further, in some embodiments, the application server 125 may be configured to determine whether one or more content elements of the HTML page (or webpage) include sensitive information. In response to determining (or receiving a determination) that a content element includes sensitive information, the application server 125 may dynamically generate and encrypt a DRM-protected video that includes an image frame that depicts or represents the sensitive information. In some aspects, the application server 125 may be configured to transmit the encrypted, DRM-protected video to the CDM 130 (which may decrypt the encrypted DRM-protected video and transmit the decrypted DRM-protected video to the user device 110).

In some aspects, the application server 125 may be configured to communicate with the API system 135, as explained above. For example, the application server may be configured to receive, from the API system 135, a JSON object that includes (i) one or more content elements representing sensitive information (and optionally non-sensitive information) and (ii) formatting information associated with the one or more content elements. Upon receiving the JSON object, the application server 125 may be configured to generate (or convert the JSON object into) a video that includes a single image frame, where the single image frame represents (or depicts) the one or more content elements in accordance with the formatting information. In some aspects, the video may be configured to play the single image frame in a loop. Further, the video may be associated with (e.g., protected by) a DRM technology, and be encrypted. When decrypted, the video may be (i) configured play on the display 116 of the user device 110 when the display 116 is not being screenshared or screenshotted, and (ii) configured to not play on the display 116 when the display 116 is being screenshared or screenshotted. Further, the video may correspond to a video requested in an API request previously sent from the user device 110 to the API server 135. In some embodiments, the application server 125 may be configured to transmit the encrypted video to the CDM 130, which may decrypt the encrypted video and then transmit the decrypted video to the user device 110.

While the example above involves the application server 125 generating (or converting the JSON object) into a single DRM-protected video that is encrypted, in some embodiments, the application server 125 may generate (or convert one or more JSON objects) into one or more DRM-protected videos that are encrypted. Further, in some embodiments, the application server 125 may be configured to store one or more DRM-protected videos in a storage component of the application server 125, elsewhere on the network 120, on a cloud storage component, or at a location accessible by the user device 110.

In some aspects, the CDM 130 (or DRM platform 130) may be configured to communicate with the user device 110, the API system 135, and the application server 125, via the network 120. For example, the CDM 130 may be configured to receive an encrypted, DRM-protected video from the application server 125 (or elsewhere on the network 120). The CDM 130 may also be configured to decrypt the encrypted, DRM-protected video, and transmit the decrypted, DRM-protected video to the user device 110 (e.g., to the browser module 112 or the operating system module 113).

In various embodiments, the network 120 may be a wide area network (“WAN”), a local area network (“LAN”), personal area network (“PAN”), or the like. In some embodiments, network 120 may include the Internet, and support the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page,” “website,” or “webpage” generally encompasses a location, data store, or the like that is, for example, hosted or operated by a computer system so as to be accessible online, and that may include data configured to cause a program such as a browser to perform operations such as send, receive, or process data, generate a visual display or an interactive interface, or the like.

Although depicted as separate components in FIG. 1, it should be understood that a component or portion of a component in the environment 100 may, in some embodiments, be integrated with or incorporated into one or more other components. For example, in some embodiments, at least a portion of the application server 125, the API system 135, or the CDM 130 may be integrated into the user device 110. In some embodiments, operations or aspects of one or more of the components discussed above may be distributed amongst one or more other components. Any suitable arrangement or integration of the various systems and devices of the environment 100 may be used. Further, in some embodiments, the environment 100 may include multiple user devices 110, multiple API systems 135, multiple application servers 125, or multiple CDMs 130.

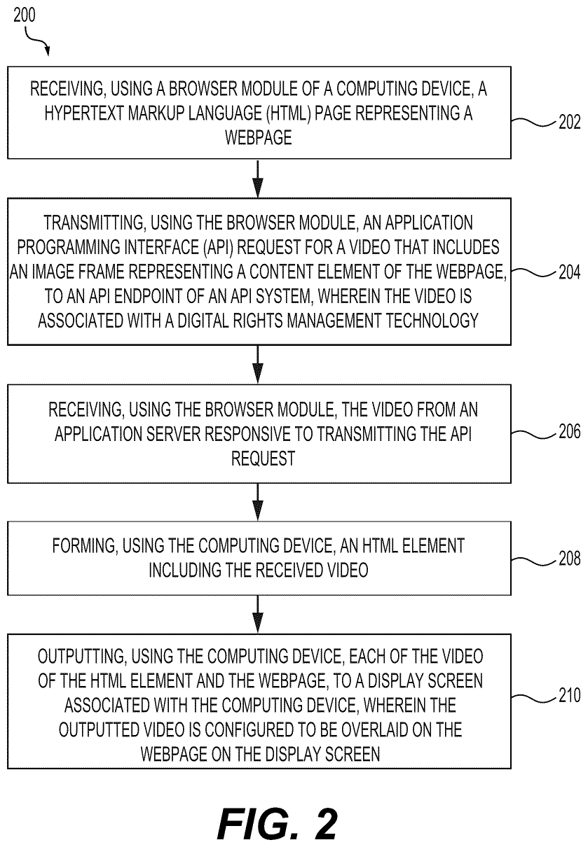

FIG. 2 is a flowchart illustrating a method 200 for securing content of a website (or a webpage, portal, application, etc.), according to one or more embodiments of the present disclosure. In some aspects, the method 200 may be performed by a computing device (e.g., the user device 110), and using, for example, JavaScript.

As shown in FIG. 2, the method 200 may include receiving, using a browser module (e.g., the browser module 112) of a computing device (e.g., the user device 110), an HTML page representing a webpage (202). In some embodiments, the HTML page may not include a content element of the webpage, where the content element represents, for example, the only sensitive information included in the webpage. In some embodiments, the browser module may be configured to receive the content element representing the sensitive information only when the content element is depicted in an image frame of a DRM-protected video, in order to protect the content element from being accessed or viewed by an unauthorized user.

In some embodiments, the method 200 may include determining, using the browser module, that the content element is not included (or not directly included) in the HTML page of the webpage. The method 200 may include transmitting, using the browser module, an API request for a video that includes an image frame representing the content element of the webpage, to an API endpoint (e.g., the first API endpoint 136) of an API system (e.g., the API system 135), where the video is associated with (e.g., protected by) a DRM technology (204) (e.g., responsive to determining that the content element is not included in the HTML page). Further, in some embodiments, the API request may further include formatting information associated with the content element. In some aspects, the requested DRM-protected video may be configured to (i) play the image frame representing the content element in a loop on a display screen (e.g., the display 116) associated with the computing device when the display screen is not being screenshared or screenshotted, and (ii) not play on the display screen when the display screen is being screenshared or screenshotted.

The method 200 may include receiving, using the browser module, the video from an application server (e.g., the application server 125) responsive to transmitting the API request (206). The method 200 may include forming, using the computing device (e.g., the browser module 112 or the operating system module 113), an HTML element including the received video (208). In some embodiments, the HTML element may be included (or inserted) in the HTML page representing the webpage. The method 200 may include outputting, using the computing device, each of the video of the HTML element and the webpage, to the display screen associated with the computing device, where the outputted video is configured to be overlaid on (e.g., a background color of) the webpage on the display screen (210). In some aspects, the video of the HTML element may be rendered using a player (e.g., the player 115, which may be programmed in JavaScript). Further, the video may be played on the display screen using the player.

In some aspects, because the browser module may receive the content element representing the sensitive information only when the content element is represented in the DRM-protected video, the content element may be protected from unauthorized access (e.g., by a social engineer or malicious web application) as soon as the browser module receives the DRM-protected video. Further, the content element remains protected when the DRM-protected video and webpage are loaded, or represented as a DOM, on the computing device. Accordingly, a social engineer or malicious web application cannot access or view the content element represented in the DOM. Further, when the DRM-protected video is displayed on the display screen, the content element is protected because the DRM-protected video is configured to play only when the display screen is not being screenshared with, or screenshotted for, a social engineer or potential social engineer. Accordingly, the method 200 provides an end-to-end process for securing a content element that may include sensitive information.

While a webpage including (or associated with) only one content element representing sensitive information is described above, in some embodiments, the webpage may include (or be associated with) multiple content elements representing at least one of sensitive information or non-sensitive information, using the method 200 or a variation thereof (or using asynchronous JavaScript).

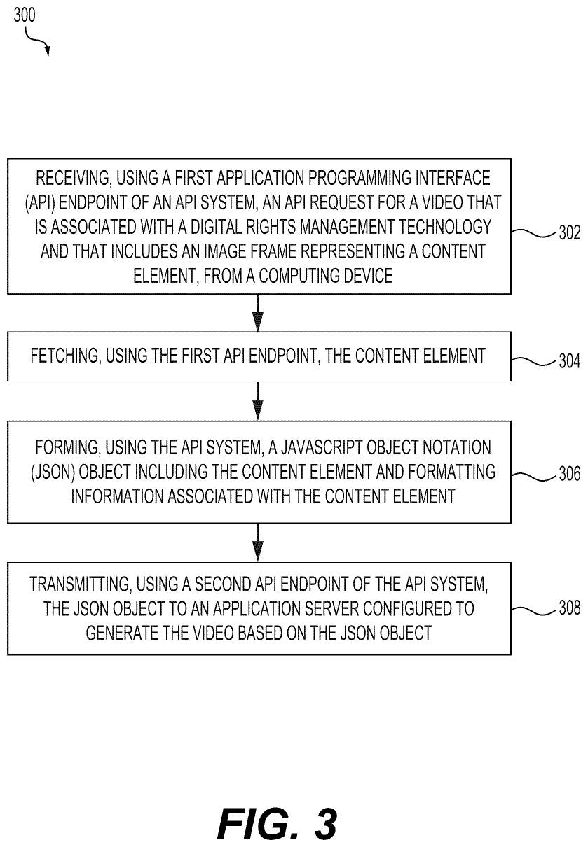

FIG. 3 is a flowchart illustrating a method 300 for securing content of a website (or a webpage, portal, application, etc.), according to one or more embodiments of the present disclosure. In some aspects, the method 300 may be performed by an API system (e.g., the API system 135), and using, for example, JavaScript. Further, the method 300 may be an embodiment of the method 200 of FIG. 2.

As shown in FIG. 3, the method 300 may include receiving, using a first application programming interface (API) endpoint (e.g., the first API endpoint 136) of an API system (e.g., the API system 135), an API request for a video that is associated with (e.g., protected by) a digital rights management technology and that includes an image frame representing a content element, from a computing device (e.g., the user device 110) (302). In some embodiments, the API system may receive the API request using JavaScript. Further, in some embodiments, the content element may represent sensitive information of a webpage, and be associated with formatting information. The formatting information may indicate how the content element should be presented in the image frame of the video. In some embodiments, the API request may include the formatting information. In some other embodiments, the API request may not include the formatting information. In some aspects, the video requested in the API request may be encrypted and configured to (i) play the image frame in a loop on a display screen (e.g., the display 116) associated with the computing device when the display screen is not being screenshared or screenshotted, and (ii) not play (or be blocked from playing) on the display screen when the display screen is being screenshared or screenshotted.

The method 300 may include fetching, using the first API endpoint (and, for example, JavaScript), the content element (304). The method 300 may also include forming, using the API system, a JavaScript Object Notation (JSON) object including the content element and formatting information associated with the content element (306). In some embodiments, the content element may be represented as a string in the JSON object. Further, in some embodiments, the method 200 may include transmitting, using the first API endpoint (and, for example, JavaScript) the JSON object to a second API endpoint (e.g., the second API endpoint 137) of the API system. The method 300 may further include transmitting, using the second API endpoint of the API system, the JSON object to an application server (e.g., the application server 125) configured to generate the video based on the JSON object (308).

While only a single API request is described above, in some embodiments, multiple API requests may be received and processed using the method 300 or a variation thereof (or using asynchronous JavaScript).

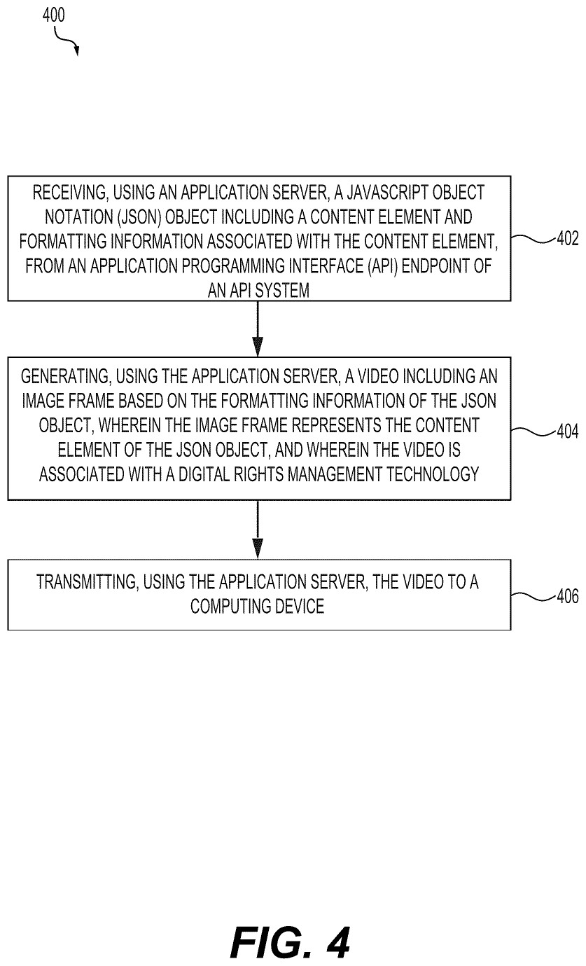

FIG. 4 is a flowchart illustrating a method 400 for securing content of a website (or a webpage, portal, application, etc.), according to one or more embodiments of the present disclosure. In some aspects, the method 400 may be performed by an application server (e.g., the application server 125), and using, for example, JavaScript. Further, the method 400 may be an embodiment of the method 200 of FIG. 2 or the method 300 of FIG. 3.

As shown in FIG. 4, the method 400 may include receiving, using an application server (e.g., the application server 125), a JSON object including a content element and formatting information associated with the content element, from an API endpoint (e.g., the second API endpoint 137) of an API system (e.g., the API system 135) (402). In some embodiments, the content element may include sensitive information of a webpage. The method 400 may include generating, using the application server, a video including an image frame based on the formatting information of the JSON object, where the image frame represents the content element of the JSON object, and where the video is associated with (e.g., protected by) a DRM technology (404). In some embodiments, the video may be encrypted and configured to (i) play the image frame in a loop on a display screen (e.g., the display 116) associated with a computing device (e.g., the user device 110) when the display screen is not being screenshared or screenshotted, and (ii) not play (or be blocked from playing) on the display screen when the display screen is being screenshared or screenshotted. The method 400 may further include transmitting, using the application server, the video to the computing device (406). The video may be transmitted to the computing device via a content decryption module (e.g., the CDM 130).

In general, any process or operation discussed in this disclosure that is understood to be computer-implementable, such as the processes (or methods) illustrated in FIGS. 2, 3, and 4, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

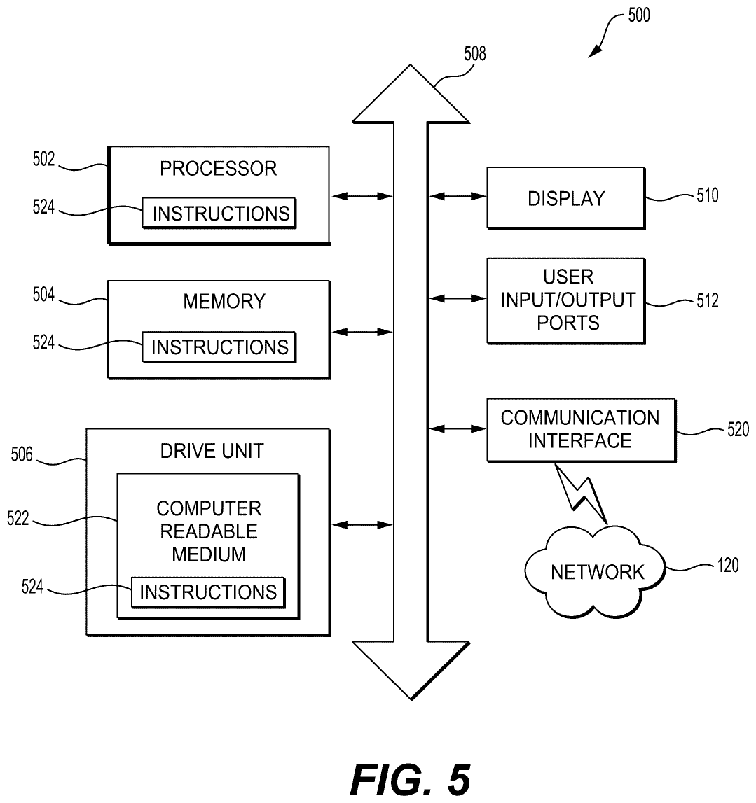

FIG. 5 is a simplified functional block diagram of a computer 500 that may be configured as a device for executing the methods of FIG. 2, 3, or 4, according to exemplary embodiments of the present disclosure. For example, in some embodiments, the computer 500 may be configured as the user device 110, according to exemplary embodiments of this disclosure. In some other embodiments, the computer 500 may be configured as the application server 125, according to exemplary embodiments of this disclosure. In some other embodiments, the computer 500 may be configured as the API system 135, according to exemplary embodiments of this disclosure. In some other embodiments, the computer 500 may be configured as the CDM 130, according to exemplary embodiments of this disclosure. In various embodiments, any of the devices or systems herein may be a computer 500 including, for example, a data communication interface 520 for packet data communication. The computer 500 also may include a central processing unit (“CPU”) 502, in the form of one or more processors, for executing program instructions. The computer 500 may include an internal communication bus 508, and a storage (or drive) unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 or computer readable medium 522). The computer 500 also may include input and output ports 512 or a display (or display screen) 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
receiving, using a first application programming interface (API) endpoint of an API system, an API request for a video that is associated with a digital rights management technology and that includes an image frame representing a content element, from a computing device;
fetching, using the first API endpoint, the content element;
forming, using the API system, a JavaScript Object Notation (JSON) object including the content element and formatting information associated with the content element; and
transmitting, using a second API endpoint of the API system, the JSON object to an application server configured to generate the video based on the JSON object.

2. The method of claim 1, further comprising:
receiving, using the second API endpoint and JavaScript, the JSON object responsive to forming the JSON object.

3. The method of claim 1, wherein the content element is represented as a string in the JSON object.

4. The method of claim 1, wherein the API request includes the formatting information.

5. The method of claim 1, wherein the formatting information indicates how the content element should be presented in the image frame of the video.

6. The method of claim 1, wherein receiving, using the first API endpoint of the API system, the API request comprises:
receiving, using the first API endpoint of the API system and JavaScript, the API request.

7. The method of claim 1, wherein the video is encrypted and configured to play the image frame in a loop.

8. The method of claim 1, wherein the video is configured to play on a display screen associated with the computing device when the display screen is not being screenshared or screenshotted.

9. The method of claim 1, wherein the video is configured to not play on a display screen associated with the computing device when the display screen is being screenshared or screenshotted.

10. The method of claim 1, wherein the content element represents sensitive information of a webpage.

11. A system comprising:
at least one processor; and
at least one memory having programming instructions stored thereon, which, when executed by the at least one processor, cause the system to perform operations comprising:
receiving, using a first application programming interface (API) endpoint, an API request for a video that is associated with a digital rights management technology and that includes an image frame representing a content element, from a computing device;
fetching, using the first API endpoint, the content element;
forming, using an API system, a JavaScript Object Notation (JSON) object including the content element and formatting information associated with the content element; and
transmitting, using a second API endpoint, the JSON object to an application server configured to generate the video based on the JSON object.

12. The system of claim 11, wherein the API system includes the first API endpoint and the second API endpoint.

13. The system of claim 11, wherein the operations further comprise:
receiving, using the second API endpoint and JavaScript, the JSON object responsive to forming the JSON object.

14. The system of claim 11, wherein the content element is represented as a string in the JSON object.

15. The system of claim 11, wherein the API request includes the formatting information.

16. The system of claim 11, wherein the formatting information indicates how the content element should be presented in the image frame of the video.

17. The system of claim 11, where receiving, using the first API endpoint, the API request comprises:
receiving, using the first API endpoint and JavaScript, the API request.

18. The system of claim 11, wherein the video is encrypted and configured to play the image frame in a loop.

19. The system of claim 11, wherein the content element represents sensitive information of a webpage, wherein video is configured to play on a display screen associated with the computing device when the display screen is not being screenshared or screenshotted, and wherein the video is configured to not play on the display screen when the display screen is being screenshared or screenshotted.

20. A method comprising:
receiving, using a first application programming interface (API) endpoint of an API system, an API request for a video that is associated with a digital rights management technology and that includes an image frame representing sensitive information, from a computing device;
fetching, using the first API endpoint, the sensitive information;
forming, using the API system, a JavaScript Object Notation (JSON) object including the sensitive information and formatting information associated with the sensitive information; and
transmitting, using a second API endpoint of the API system, the JSON object to an application server configured to generate the video based on the JSON object.
